(19) United States
(12) Patent Application Publication
(10) Pub. No.: US 2007/0201718 A1
(43) Pub. Date: Aug. 30, 2007

(54) Speaker

(76) Inventors: Ryo Shimoe, Toride-Shi (JP); Hiroki Fujimori, Fukuroi-Shi (JP); Hirokazu Yonemori, Kakegawa-Shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/710,932

(22) Filed: Feb. 27, 2007

(30) Foreign Application Priority Data
Feb. 27, 2006 (JP) 2006-50946

(51) Int. Cl. H04R 9/06; H04R 11/02; H04R 1/00

(52) U.S. Cl. 381/396; 381/398; 381/412

(57) ABSTRACT

A speaker is provided in which first and second voice coils are disposed around a voice coil bobbin, a diaphragm has its inner circumferences attached to an area of the voice coil bobbin positioned between the first and second voice coils and its outer circumference supported at the forefront portion of the frame via a surround, and a spider has its inner circumference attached to an area of the voice coil bobbin positioned between the first and second voice coils and its outer circumference supported at the middle portion of the frame. Since the outer circumferences of the diaphragm and the spider are attached to the voice coil bobbin at the area(s) between the first and second voice coils, the axial length of the voice coil bobbin can be reduced, and consequently the entire axial length of the speaker can bereduced.

### BACKGROUND OF THE INVENTION

1. Field of the Invention

The present invention relates to a speaker for use in various audio equipment.

2. Description of the Related Art

A speaker is disclosed in which the magnetic flux density distribution of a magnetic gap with a voice coil disposed therein is uniformed, whereby the second harmonic distortion at the lower frequency range of the speaker is suppressed (refer to Japanese Patent Application Laid-Open No. H8-331691).

FIG. 10 is a schematic cross sectional view of a magnetic circuit area of a speaker as disclosed in the aforementioned Japanese Patent Application Laid-Open No H8-331691. The speaker of FIG. 10 includes: a magnetic circuit including a magnet 11, and top and bottom plates 112 and 113 disposed respectively at the front and rear sides of the magnet 11; a voice coil bobbin 1 disposed outside the magnetic circuit; two voice coils 2 and 3 disposed around the voice coil bobbin 1 and wound in the respective directions opposite to each other; and a yoke 15 disposed outside the voice coils 2 and 3, wherein a magnetic gap 14 is formed between the magnetic circuit and the yoke 15, and the voice coil bobbin 1 having the voice coils 2 and 3 therearound is held in the magnetic gap 14. Since the two voice coils 2 and 3 are wound in the opposite directions, the magnetic flux density distribution in the magnetic gap 14 can be uniformed, and therefore the second harmonic distortion can be suppressed.

The speaker of FIG. 10, however, has the following problems. Since the yoke 15 is disposed so as to enclose the magnet 11 and the two voice coils 2 and 3, it is physically difficult to join the inner circumference of a spider and the inner circumference of a diaphragm to the voice coil bobbin 1 at an area between the two voice coils 2 and 3. FIG. 11 is a cross sectional view of a relevant portion of the speaker disclosed in the aforementioned Japanese Patent Application Laid-Open No H8-331691, showing an example joint of a diaphragm 7 and a spider 8 to the voice coil bobbin 1. As shown in FIG. 11, the inner circumferences of the diaphragm 7 and the spider 8 must be joined to the voice coil bobbin 1 at an area positioned forward of the yoke 15 (above the yoke 15 in the figure), thus increasing the axial length of the voice coil bobbin 1 and therefore making it difficult to reduce the axial length of the speaker. Also, the presence of the yoke 15 forces the speaker to increase in weight.

Further, there is a problem with radiation of heat generated at a voice coil. When a large electric power signal is inputted to the speaker, heats generated at the voice coils 2 and 3 are caused to increase. The heats conduct through the magnetic gap 14 to the yoke 15 and are radiated from the yoke 15. If the yoke 15 has an insufficient radiation capability, the heats from the voice coil 2 and 3 are caused to conduct via the air to the top and bottom plates 112 and 113 and further to the magnet 11, and the magnet 11 is heated up to a high temperature and therefore degaussed, thus deteriorating the sound quality. Increase of the surface area of the yoke 15 is an effective method for enhancing the radiation capability of the yoke 15, but this method makes it difficult to reduce the dimension and weight of the speaker. Specifically, if the yoke 15 is increased in its radial dimension (horizontal direction in FIG. 11), the weight of the yoke 15 is caused to increase. And if the yoke 15 is increased in its axial length (vertical direction in FIG. 11), then the axial length of the yoke 15 is caused to increase. Thus, the increase of the dimension of the yoke 15 forces the speaker to increase in dimension and/or weight as a whole.

### SUMMARY OF THE INVENTION

The present invention has been made in light of the above problems, and it is an object of the present invention to provide a speaker in which heats generated at voice coils are adapted to efficiently radiate without causing an increase in weight and dimension, thus preventing the performance degradation of a magnet.

In order to achieve the object described above, according to an aspect of the present invention, there is provided a speaker which includes: a voice coil bobbin; first and second voice coils disposed around the voice coil bobbin and arranged to generate their respective electromagnetic forces in the same direction, the first voice coil positioned forward of the second voice coil; a magnetic circuit including a magnet disposed in the bobbin and magnetized in the direction along the axis of the voice coil bobbin, and first and second plates disposed respectively at the front and rear sides of the magnet; a frame to support the magnetic circuit; a diaphragm having its inner circumference attached to the voice coil bobbin and its outer circumference supported at the forefront portion of the frame via a surround; and a spider having its inner circumference attached to the voice coil bobbin and its outer circumference supported at the frame. In the speaker described above, the inner circumference of the diaphragm and/or the spider is connected to an area of the voice coil bobbin positioned either abreast of or rearward of the first voice coil.

In the aspect of the present invention, the inner circumference of the spider may be connected to an area of the voice coil bobbin positioned between the first and second voice coils, and the inner circumference of the diaphragm may be connected to an area of the voice coil bobbin positioned forward of the first voice coil.

In the aspect of the present invention, the speaker may further include a heat sink attached to front and/or rear sides of the magnetic circuit.

In the aspect of the present invention, the heat sink may be connected to the first plate which constitutes the front side of the magnetic circuit.

In the aspect of the present invention, the forefront of the heat sink may be positioned rearward of a plane defined to the forefront of the frame.

In the aspect of the present invention, wherein the heat sink has a shaft formed at the center of the rear face thereof so as to extend rearward, the shaft may be inserted through a hole formed at the center of the magnetic circuit, and a nut is fitted on the distal end of the shaft.

In the aspect of the present invention, the heat sink may be connected to the second plate which constitutes the rear side of the magnetic circuit.

In the aspect of the present invention, a magnetic circuit attachment portion attached to the second plate may be formed at the center of the heat sink, and the outer circumference of the heat sink may be attached to the rear portion of the frame.

In the aspect of the present invention, the magnetic circuit attachment portion of the heat sink may protrude in the forward direction.

In the aspect of the present invention, the speaker may further includes a dust cap disposed in front of the voice coil bobbin, and a heat sink attached to the second plate constituting the rear side of the magnetic circuit.

In the aspect of the present invention, the heat sink may be attached to the magnetic circuit by means of caulking.

The speaker described above can achieve enhancement of performance of radiating heats generated at the voice coils without involving increase of dimension and weight, thus preventing the magnet from deteriorating in performance.

### BRIEF DESCRIPTION OF THE DRAWINGS

FIG. 1 is a cross sectional view of a speaker according to a first embodiment of the present invention;

FIG. 2A is a schematic view of magnetic flux directions around a magnetic circuit of the speaker of FIG. 1, and FIG. 2B is a schematic view of magnetic flux directions when a circular-cylindrical yoke is provided around a voice coil bobbin;

FIG. 3 is a cross sectional view of a speaker according to a second embodiment of the present invention;

FIG. 4 is an enlarged cross sectional view of a portion of the speaker of FIG. 3, showing a positional relation among a first heat sink, a magnetic circuit, and a voice coil bobbin;

FIG. 5 is a cross sectional view of an example speaker derived from the second embodiment, wherein two heat sinks are fixedly attached to a magnetic circuit by a screwing method;

FIG. 6 is a cross sectional view of a speaker according to a third embodiment of the present invention;

FIG. 7 is a cross sectional view of an example speaker derived from the third embodiment, wherein a heat sink is fixedly attached to a magnetic circuit by a riveting method;

FIG. 8 is a schematic view of a structure of a rivet used in the riveting method shown in FIG. 7;

FIGS. 9A and 9B are schematic views of the rivet of FIG. 8 inserted through holes of the magnetic circuit and the heat sink, respectively before and after a pin of the rivet is pulled;

FIG. 10 is schematic cross sectional view of a magnetic circuit area in a conventional speaker; and

FIG. 11 is a cross sectional view of a relevant portion of a conventional speaker, showing an example joint of a diaphragm and a spider to a voice coil bobbin.

### DETAILED DESCRIPTION OF THE INVENTION

Exemplary embodiments of the present invention will hereinafter be described with reference to the accompanying drawings.

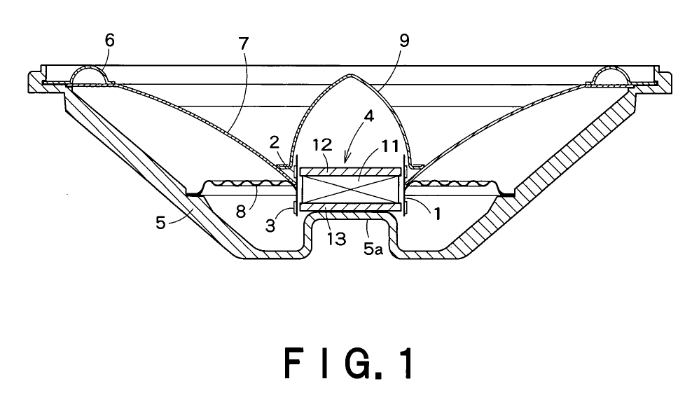

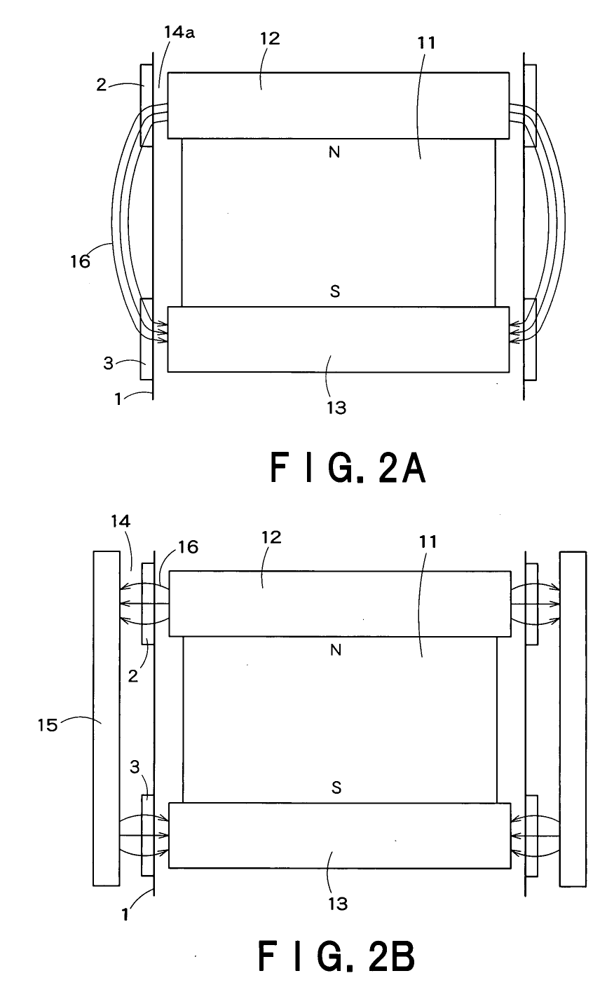

A first embodiment of the present invention will be described with reference to FIGS. 1, 2A and 2B. Referring to FIG. 1, a speaker according to the first embodiment includes: a voice coil bobbin (hereinafter referred to simply as “bobbin” as appropriate) 1; first and second voice coils 2 and 3 wound in respective directions opposite to each other so as to generate their respective electromagnetic forces in the same direction; a magnetic circuit 4 disposed inside the bobbin 1; a frame 5 having the magnetic circuit 4 fixed thereto; a cone diaphragm 7 (hereinafter referred to simply as “diaphragm”) having its inner circumference attached to the bobbin 1 and its outer circumference supported at the front portion (upper portion in the figure) of the frame 5 via a surround 6; a spider 8 having its inner circumference attached to the bobbin 1 and its outer circumference supported at the middle portion of the frame 5; and a dust cap 9 to cover the front portion (upper portion in the figure) of the bobbin 1.

The magnetic circuit 4 includes a magnet 11 magnetized in the direction along the axis of the bobbin 1, a first plate 12 attached to the front side (upper side in the figure) of the magnet 11, and a second plate 13 attached to the rear side (lower side in the figure) of the magnet 11. The inner circumferences of the diaphragm 7 and the spider 8 are connected to an area of the bobbin 1 positioned between the first and second voice coils 2 and 3, whereby the axial length of the bobbin 1 can be reduced, thus also reducing the entire axial length of the speaker.

Because the directions of magnetic fluxes generated respectively at the first and second plates 12 and 13 are opposite to each other, the first and second voice coils 2 and 3 are wound in the opposite directions as described above so that current applied to the speaker is caused to flow in opposite directions respectively at the first and second voice coils 2 and 3, which results in allowing respective forces generated at the first and second voice coils 2 and 3 to be oriented in the same direction. In this connection, the first and second voice coils 2 and 3 do not have to be wound in the opposite directions insofar as they produce their respective electromagnetic forces in the same direction.

The speaker of FIG. 1 is not provided with a yoke, that is what is called a “yokeless structure”. In the yokeless structure, magnetic force lines 16 are generated between the outer circumference of the first plate 12 and the outer circumference of the second plate 13 as shown in FIG. 2A. On the other hand, referring to FIG. 2B, in a speaker provided with a yoke 15, magnetic force lines 16 are generated between the yoke 15 and the outer circumferences of the first and second plates 12 and 13. In both structures, when an AC current is applied to the first and second voice coils 2 and 3, the bobbin 1 can vibrate in the axial direction.

The yokeless structure may possibly allow less magnetic flux to interlink the first and second voice coils 2 and 3, but since the first and second voice coils 2 and 3 are disposed close to the first and second plates 12 and 13, respectively, the speaker achieves an adequate performance. Also, due to no yoke provided, the inner circumferences of the diaphragm 7 and the spider 8 can be connected to any portion at the outer circumference of the bobbin 1, for example, at an area between the first and second voice coils 2 and 3 as in the present embodiment. This allows the axial length of the bobbin 1 to be shortened, thus enabling reduction of the axial length of the speaker. Also, the speaker can take off the weight of the yoke 15. For the reasons described above, a yokeless structure is employed in the present embodiment.

The frame 5 is a single component made of resin. A magnetic circuit attachment portion 5a to which the rear side of the magnetic circuit 4 is attached is formed at the center of the rear portion (bottom portion in the figure) of the frame 5. Heats generated at the first and second voice coils 2 and 3 are conducted to the frame via the magnetic circuit 4. Therefore, the frame 5 is made of, for example, a heat-resistant plastic, more specifically a heat-resistant ABS (acrylonitrile butadiene styrene), and PP (polypropylene). The frame 5 made of resin, such as plastic, is suitable for weight reduction but does not achieve so good radiation performance as a metallic frame. So, if weight reduction is not an important consideration, then the frame 5 may be made of non-magnetic steel excellent in heat radiation (e.g. aluminum).

Thus, since the inner circumferences of the diaphragm 7 and the spider 8 are connected to the bobbin 1 at an area between the first and second voice coils 2 and 3 in the first embodiment of the present invention, the axial length of the bobbin 1 can be reduced, thus also reducing the entire axial length of the speaker. And, since there is no yoke provided, the speaker can be reduced in weight.

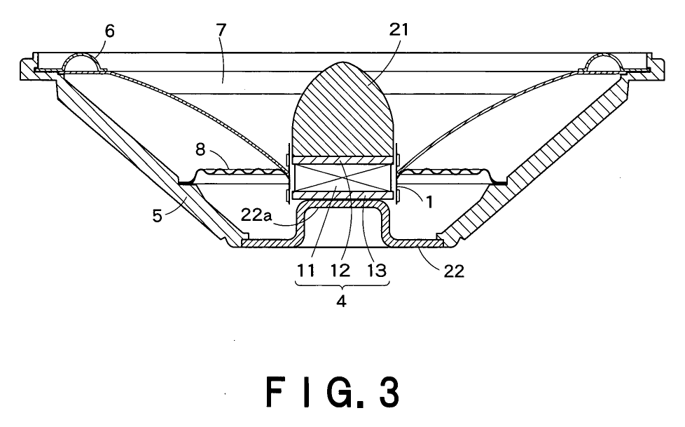

A second embodiment of the present invention will be described with reference to FIGS. 3 to 5. FIG. 3 shows a speaker according to the second embodiment, which features provision of heat sinks. In explaining the example of FIG. 3, any component parts corresponding to those in FIG. 1 are denoted by the same reference numerals, and description will be focused on the differences from the first embodiment of FIG. 1.

The speaker of FIG. 3 includes first and second voice coils 2 and 3, a magnetic circuit 4, a cone diaphragm 7, and a spider 8, which are structured and arranged in the same way as the speaker of FIG. 1. The speaker of FIG. 3 further includes a first heat sink 21 attached to the front side of the magnetic circuit 4, and a second heat sink 22 attached to the rear side of the magnetic circuit 4. The first heat sink 21 is formed in a bullet shape and has its center portion projecting in the front direction of the speaker. The front end of the first heat sink 21 is positioned rearward of the plane of the forefront (uppermost in the figure) of a frame 5 of the speaker.

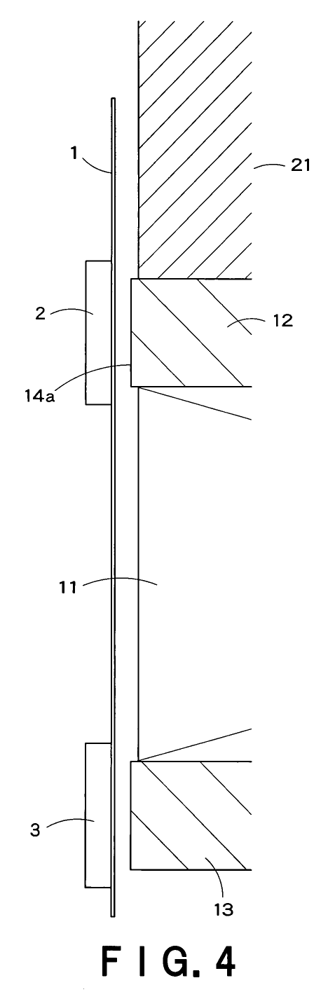

Referring now to FIG. 4, the first heat sink 21 is attached to a first plate 12 of the magnetic circuit 4, and a bobbin 1 is disposed outside the first heat sink 21 and the first plate 12 with a gap 14a provided therefrom. The first heat sink 21 has a diameter equal to or smaller than the first plate 12. The second heat sink 22 has its outer circumference attached to the rear portion of the frame 5 and includes a magnetic circuit attachment portion 22a formed at its center as shown in FIG. 3. The magnetic circuit attachment portion 22a is attached to a second plate 13 of the magnetic circuit 4 by, for example, heat-resistant adhesive. The first and second heat sinks 21 and 22 are made of non-magnetic steel excellent in radiation performance (e.g. aluminum).

The speaker of FIG. 3 is of yokeless structure like the speaker of FIG. 1, and the inner circumferences of the diaphragm 7 and the spider 8 are connected to an area of the bobbin 1 positioned between the first and second voice coils 2 and 3. Accordingly, the axial length of the bobbin 1 in the speaker of FIG. 3 can be reduced in the same way as the speaker of FIG. 1.

Description will be made on the heat radiation mechanism of the speaker according to the second embodiment. When a large electric power signal is applied to a speaker in succession, the voice coils 2 and 3 are heated, and the heats of the voice coils 2 and 3 conduct via the air to the first and second plates 12 and 13. Since the first and second heat sinks 21 and 22 are attached to the first and second plates 12 and 13, respectively, the heats at the first and second plates 12 and 13 are adapted to promptly conduct to the first and second heat sinks 21 and 22 and are radiated therefrom.

In order to enhance the heat radiation efficiency of the first and second heat sinks 21 and 22, it is effective to increase the volumes and surface areas of the first and second heat sinks 21 and 22. The surface areas may be increased by increasing the dimensions of the first and second heat sinks 21 and 22, but this method leads to an undesirable increase in the overall dimension of the speaker. Alternatively, the surface areas may desirably be increased by forming ribs at the surfaces or by roughening the surfaces of the first and second heat sinks 21 and 22. In this connection, since the shape of the first heat sink 21 may possibly have an impact on acoustic characteristics (especially, at the treble range), the first and second heat sinks 21 and 22 should be configured with such acoustic characteristics taken into consideration.

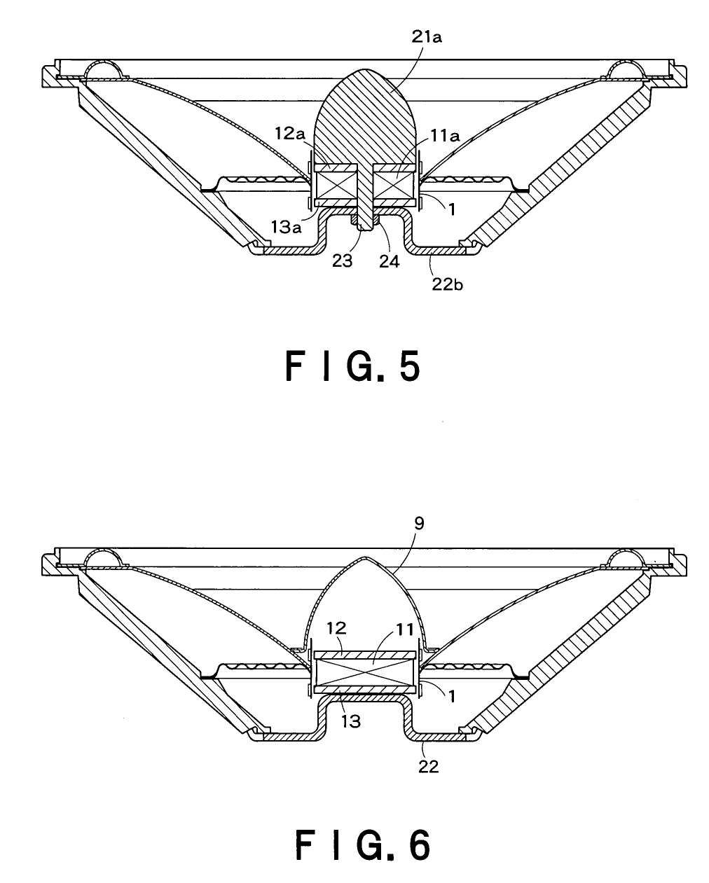

In the speaker according to the second embodiment, the first and second heat sinks 21 and 22 may be fixedly attached to the magnetic circuit 4 by heat-resistant adhesive, by means of screwing, or caulking. Referring to FIG. 5, first and second heat sinks 21a and 22b are fixedly attached to the magnetic circuit 4 by a screwing method. The first heat sink 21a, which is disposed at the front side of the magnetic circuit 4, has a shaft 23 integrally formed at the center thereof so as to extend rearward. The distal end portion of the shaft 23 is threaded. A hole for inserting the shaft 23 therethrough is formed at the center of the magnetic circuit 4, specifically each of a first plate 12a, a magnet 11a and a second plate 13a, and also the second heat sink 22b has a hole at its center.

The hole of the second heat sink 22b is aligned to the hole of the magnetic circuit 4, then the shaft 23 of the first heat sink 21a is inserted through the both holes from the front side of the magnetic circuit 4 so as to have its threaded end portion sticking out from the rear side of the second heat sink 22b, and a nut 24 is screwed onto the threaded portion of the shaft 23. This way, the first and second heat sinks 21a and 22b can be fixed to the magnetic circuit 4 simply and firmly, and heat radiation performance can be enhanced. In this connection, the nut 24 does not have to be screwed on to the shaft 23 but may be, for example, press-fitted onto the shaft 23 which has a plain distal end portion.

As described above, in the speaker according to the second embodiment, since the first heat and second heat sinks 21a and 22b are attached respectively to the front and rear sides of the magnetic circuit 4, heats generated at the first and second voice coils 2 and 3 and conducted to the first and second plates 12a and 13a can be promptly radiated from the first and second heat sinks 21a and 22b. Consequently, the first and second voice coils 2 and 3, and the magnetic circuit 4 are not heated up to a high temperature, and therefore a magnet 11a of the magnetic circuit 4 is prevented from deteriorating in performance. Also, since the speaker according to the second embodiment can be of yokeless structure as the speaker according to the first embodiment so that the diaphragm 7 and spider 8 are connected to a bobbin 1 at an area between the first and second voice coils 2 and 3, the axial length of the bobbin 1 can be shortened, thus allowing the speaker to achieve reduction in dimension and weight.

A third embodiment of the present invention will be described with reference to FIGS. 6 to 9A and 9B. FIG. 6 shows a speaker according to the third embodiment, which, unlike the second embodiment, includes only one heat sink. In explaining the example of FIG. 6, any component parts corresponding to those in FIGS. 1 and 3 are denoted by the same reference numerals, and description will be focused on the differences from the first and second embodiments of FIGS. 1 and 3.

In the speaker of FIG. 6, a dust cap 9 is provided above a bobbin 1 in the same way as in the speaker of FIG. 1, and a heat sink 22, which corresponds to the second heat sink 22 of the speaker of FIG. 3, is provided at the rear portion of a frame 5. The speaker of FIG. 6 is not provided with the first heat sink 21 which is provided in the speaker of FIG. 3, thus having only one heat sink, and therefore the speaker of FIG. 6 is less effective in heat radiation than the speaker of FIG. 3, but achieves weight reduction while dust and dirt are prevented from getting in the gap 14a.

The third embodiment is preferable when first and second voice coils 2 and 3 do not generate so much heat, in which case heats conducted from the first and second voice coils 2 and 3 to a magnetic circuit 4 can be duly radiated from the heat sink 22 alone, thus eliminating requirement of the first heat sink 21 as provided in the second embodiment.

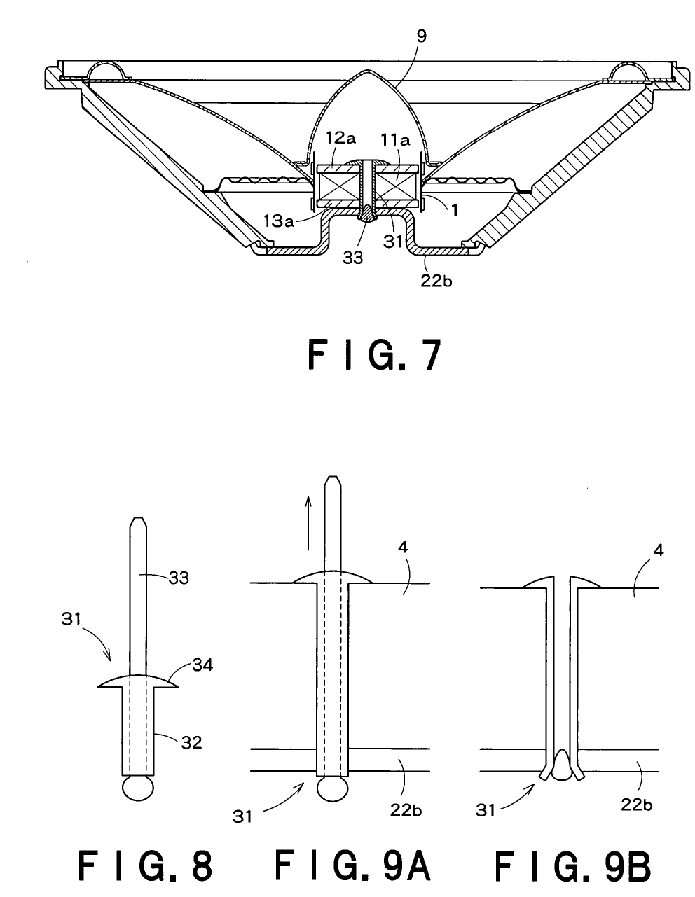

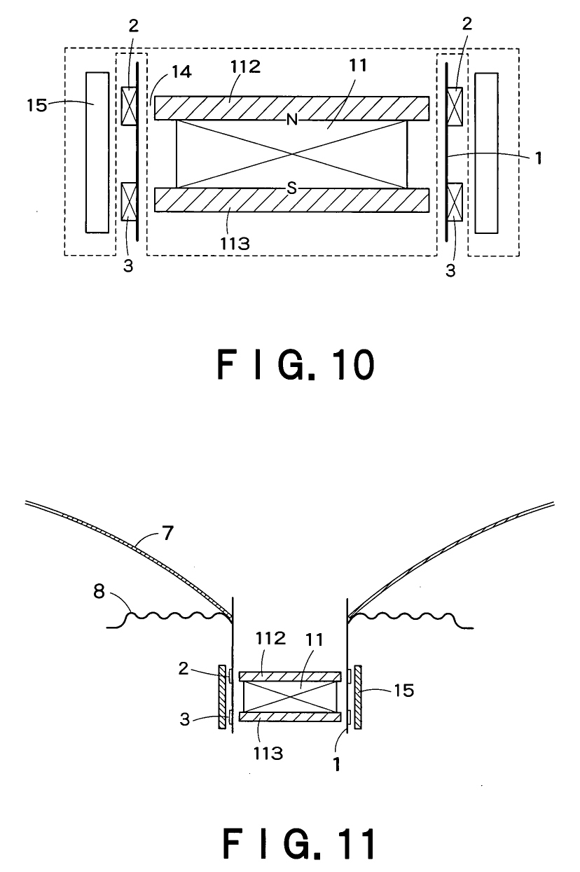

As an alternative example of the third embodiment, though not illustrated, the first heat sink 21 provided at the front side of the magnetic circuit 4 in the second embodiment shown in FIG. 3 may be used as it is while the second heat sink 22 is removed, thus incorporating only one heat sink as well. This alternative example may be less effective in heat radiation than the speaker of FIG. 3 but can achieve the same advantages as the speaker of FIG. 6 In the speaker of FIG. 6, the heat sink 22 may be fixedly attached to the magnetic circuit 4 by means of adhesive, screwing, or caulking. Referring to FIG. 7, a heat sink 22b is fixedly attached to a magnetic circuit 4 by a riveting method, for which a rivet 31 as shown in FIG. 8 is used. The rivet 31 includes a sleeve 32 having a head 34 integrally formed at one end thereof, and a pin 33 having a larger length than the sleeve 32 and inserted through the hollow of the sleeve 32. The pin 33 is movable through the sleeve 32 and has one end which is radially enlarged so as to have a larger diameter than the hollow of the sleeve 32 and which, when inserted through the sleeve 32, is located toward an end of the sleeve 32 opposite to the end having the head 34.

A hole for inserting the rivet 31 therethrough is formed at the center of each of the magnetic circuit 4 and the heat sink 22b. Referring to FIG. 9A, the rivet 31 is inserted through the holes of the magnetic circuit 4 and the heat sink 22b such that the sleeve 32 is set in the holes. Then, the pin 33 is pulled in the direction shown by an arrow in FIG. 9A so that the enlarged end of the pin 33 is forced into the hollow of the sleeve 32 thereby bulging the tip end of the sleeve 32 as shown in FIG. 9B, and the pin 33 has its enlarged end portion cut off and left in the hollow of the sleeve 32. Thus, the magnetic circuit 4 and the heat sink 22b are rigidly attached together between the head 34 and the bulged end portion of the sleeve 32 by means of caulking.

Thus, since one heat sink is provided only at either the front or rear side of the magnetic circuit 4 in the third embodiment, the speaker structure is simplified as compared with the speaker of FIG. 3, whereby the speaker weight can be reduced while cost reduction is achieved.

In the exemplary embodiments described above, the inner circumferences of the diaphragm 7 and the spider 8 are attached to the bobbin 1 at an area between the first and second voice coils 2 and 3, but may be attached to any part of the outer circumference of the bobbin 1. For example, the diaphragm 7 may be attached to at an area of the bobbin 1 positioned forward of the first voice coil 2 while the spider 8 is attached at an area between the first and second voice coils 2 and 3. Also, the diaphragm 7 in the embodiments has a cone shape but may alternatively be shaped, for example, in dome, or flat.

While the present invention has been illustrated and explained with respect to specific embodiments thereof, it is to be understood that the present invention is by no means limited thereto but encompasses all changes and modifications that will become possible within the scope of the appended claims.

What is claimed is:

1. A speaker having its sound direction defined as a forward direction, comprising:
a voice coil bobbin;
first and second voice coils disposed around the voice coil bobbin, the first voice coil positioned forward of the second voice coil;
a magnetic circuit comprising a magnet disposed in the bobbin and magnetized in a direction along an axis of the voice coil bobbin, and first and second plates disposed respectively at front and rear sides of the magnet;
a frame to support the magnetic circuit;
a diaphragm having its inner circumference attached to the voice coil bobbin and its outer circumference supported at an forefront portion of the frame via a surround; and
a spider having its inner circumference attached to the voice coil bobbin and its outer circumference supported at the frame, wherein the inner circumference of at least one of the diaphragm and the spider is connected to an area of the voice coil bobbin positioned either abreast of or rearward of the first voice coil.

2. A speaker according to claim 1, wherein the inner circumference of the spider is connected to an area of the voice coil bobbin positioned between the first and second voice coils, and the inner circumference of the diaphragm is connected to an area of the voice coil bobbin positioned forward of the first voice coil.

3. A speaker according to claim 1, further comprising a heat sink attached to at least one of front and rear sides of the magnetic circuit.

4. A speaker according to claim 3, wherein the heat sink is connected to the first plate which constitutes the front side of the magnetic circuit.

5. A speaker according to claim 4, wherein a forefront of the heat sink is positioned rearward of a forefront of the frame.

6. A speaker according to claim 4, wherein the heat sink has a shaft formed at a center of a rear face thereof so as to extend rearward, the shaft is inserted through a hole formed at a center of the magnetic circuit, and a nut is fitted on a distal end of the shaft.

7. A speaker according to claim 3, wherein the heat sink is connected to the second plate which constitutes the rear side of the magnetic circuit.

8. A speaker according to claim 7, wherein the heat sink has a magnetic circuit attachment portion formed at a center thereof and attached to the second plate, and an outer circumference of the heat sink is attached to a rear portion of the frame.

9. A speaker according to claim 8, wherein the magnetic circuit attachment portion of the heat sink protrudes in the forward direction.

10. A speaker according to claim 1, further comprising a dust cap disposed in front of the voice coil bobbin, and a heat sink attached to the second plate constituting the rear side of the magnetic circuit.

11. A speaker according to claim 7, wherein the heat sink is attached to the magnetic circuit by caulking.
